(19) United States
(12) Patent Application Publication
(10) Pub. No.: US 2024/0167854 A1
(43) Pub. Date: May 23, 2024

(54) ROTATING EQUIPMENT MONITORING DEVICE

(71) Applicant: Aktiebolaget SKF, Göteborg (SE)

(72) Inventors: Renxiang CHEN, Shanghai (CN); Zhichao Hong, Shanghai (CN)

(21) Appl. No.: 18/505,594

(22) Filed: Nov. 9, 2023

(30) Foreign Application Priority Data
Nov. 18, 2022 (CN) 202211449569.7

(51) Int. Cl. G01D 11/24; F16C 41/00; H01Q 1/22

(52) U.S. Cl. CPC G01D 11/245; F16C 41/00; H01Q 1/22; F16C 2233/00

(57) ABSTRACT

The present disclosure relates to a rotating equipment monitoring device. The rotating equipment monitoring device includes a housing having a first accommodating space and a second accommodating space. The second accommodating space is located at an end of the housing and is separated from the first accommodating space. A sensor assembly is arranged in the first accommodating space. The first accommodating space is filled with an explosion-proof medium that completely surrounds the sensor assembly. An antenna communicates with the sensor assembly and is arranged in the second accommodating space. A cover is installed on the housing via a cover installation portion at an end of a sidewall of the housing to seal the antenna in the second accommodating space.

### CROSS-REFERENCE TO RELATED APPLICATION

This application claims priority to Chinese Application No. 202211449569.7, filed Nov. 18, 2022, the entirety of which is hereby incorporated by reference.

### FIELD

The present disclosure relates to a rotating equipment monitoring device.

### BACKGROUND

Bearings are important components in mechanical equipment, mainly used to support rotating machinery, reduce friction coefficient during its movement, and ensure its rotational accuracy. Monitoring the health status of bearings in industrial equipment is an important means to ensure the normal operation of industrial equipment. Generally, rotating equipment monitoring devices, especially bearing monitoring devices, can be used to measure the speed, acceleration, temperature, vibration, etc. of bearings, and the signals obtained from the measurement will be transmitted to digital cloud platforms for analysis and diagnosis. If there is an abnormal diagnostic alarm, the customer is notified for repair or maintenance.

In some known schemes, the rotating equipment monitoring device can transmit signals through wired means, which makes the installation of rotating equipment monitoring devices more difficult and brings inconvenience to industrial equipment. In other known schemes, the rotating equipment monitoring device can use Bluetooth with low power consumption for signal transmission, but such schemes require the installation of additional gateways or routers to upload data to the cloud, which is not conducive to installation and cost control. In yet other known schemes, the rotating equipment monitoring device can use RFID technology to achieve short-range wireless transmission, but such schemes transmit less data and cannot support the required amount of data for fault diagnosis, and cannot be used for long-distance communication, making it impossible to remotely monitor equipment conditions.

There are various factors that affect antenna performance, especially transmission efficiency, in the rotating equipment monitoring device, such as metals and conductors in circuit boards, an explosion-proof medium such as AB adhesive, antenna clearance position and so on. Especially, the explosion-proof medium used to meet the Nc sealing explosion-proof certification requirements of the rotating equipment monitoring device has a significant impact on the transmission efficiency. The above various factors lead to the problem that the rotating equipment monitoring device using wireless remote communication technology cannot meet both transmission efficiency and Nc sealing explosion-proof certification requirements. To meet the transmission efficiency requirements, it is necessary to ensure that the antenna is not wrapped by the explosion-proof medium, such as AB adhesive, and maintains enough clearance from the PCBA motherboard of the sensor, so the antenna is usually arranged at the top. However, the scheme of arranging the antenna at the top usually cannot meet the explosion-proof certification requirements.

### SUMMARY

Therefore, the object of the present disclosure is to provide a rotating equipment monitoring device, wherein the antenna in the rotating equipment monitoring device is not encapsulated by an explosion-proof medium and is located in a space separated from a sensor assembly and related circuits, thus having high transmission efficiency and meeting requirements of Nc sealing explosion-proof level. The rotating equipment monitoring device also adopts narrowband wireless communication technology, thus achieving long-distance wireless transmission without gateway. In addition, the rotating equipment monitoring device has high monitoring sensitivity, good sealing performance, and therefore higher reliability.

The above object is achieved by the rotating equipment monitoring device described below.

The present disclosure provides a rotating equipment monitoring device comprising: a housing comprising a first accommodating space and a second accommodating space, wherein the second accommodating space is located at an end of the housing and separated from the first accommodating space; a sensor assembly arranged in the first accommodating space, wherein the first accommodating space is filled with an explosion-proof medium that completely surrounds the sensor assembly; an antenna configured to communicate with the sensor assembly and arranged in the second accommodating space; and a cover installed on the housing via a cover installation portion at an end of a sidewall of the housing to seal the antenna in the second accommodating space.

In an embodiment, the cover installation portion is a protrusion extending from an end face of the sidewall of the housing in a longitudinal direction, and the cover can be connected to the protrusion.

In an embodiment, the protrusion is connected to an inner surface of the cover by melting or welding the protrusion.

In an embodiment, the protrusion is set as a continuous circumferential protrusion on the end face of the sidewall of the housing or a plurality of sub protrusions intermittently arranged on the end face of the sidewall of the housing in a circumferential direction.

In an embodiment, the cover installation portion is a groove installation portion arranged above and connected to the end of the sidewall of the housing, and a circumferential edge of the cover is snapped in a groove of the groove installation portion.

In an embodiment, a notch of the groove faces an inner side of the sidewall of the housing, and the sidewalls and bottom wall of the groove installation portion are located on the outside of the sidewall of the housing.

In an embodiment, the cover installation portion comprises a transverse portion extending from the end of the sidewall of the housing in a transverse direction and at least one extension portion extending from a transverse end of the transverse portion in a longitudinal direction of the housing, and the cover comprises openings for the at least one extension portion to pass through.

In an embodiment, the cover installation portion is connected to an outer surface of the cover by melting or welding a part of the at least one extension portion on the outside of the opening.

In an embodiment, the rotating equipment monitoring device further comprises a sealing device, which is arranged between an inner surface of the cover and the end face of the sidewall of the housing, and a sealing groove is arranged on the end face of the sidewall of the housing to accommodate the sealing device.

In an embodiment, the rotating equipment monitoring device further comprises a circuit board for installing the antenna, and the cover comprises a limiting portion which extends from an inner surface of the cover towards the second accommodating space and presses against the circuit board.

The beneficial effects of the present disclosure are described below.

In the rotating equipment monitoring device mentioned above, the antenna is not encapsulated by the explosion-proof medium and is located in a space separated from the sensor assembly and related circuits. Therefore, the rotating equipment monitoring device has high transmission efficiency and can meet the requirements of Nc sealing explosion-proof level. In addition, the explosion-proof medium is used to encapsulate the sensor assembly such that the rotating equipment monitoring device has high monitoring sensitivity and good temperature resistance performance. The use of the sealing device mentioned above enables the rotating equipment monitoring device to have good sealing performance and thus high reliability.

Specifically, the rotating equipment monitoring device of the present disclosure can achieve an average transmission efficiency as high as more than 30%, which can meet the requirements of sufficiently long transmission coverage and reduce communication power consumption, thereby extending the service life of the sensor. Based on the above transmission efficiency, the rotating equipment monitoring device of the present disclosure can use narrowband wireless communication technology, such as Narrow Band Internet of Things (NB-IOT), to achieve long-distance wireless transmission, thereby achieving the function of long-distance communication and uploading data to the cloud, without relying on a gateway.

Furthermore, the rotating equipment monitoring device with a 2-zone explosion-proof rating of the present disclosure can be used in areas with gas explosion hazards and areas with dust explosion hazards, meeting the explosion-proof requirements of customers.

### BRIEF DESCRIPTION OF THE DRAWINGS

In order to clarify the technical solutions of embodiments of the present disclosure more clearly, the accompanying drawings of the embodiments of the present disclosure will be briefly introduced in the following text. Among them, the accompanying drawings are only used to illustrate some embodiments of the present disclosure, rather than limiting all embodiments of the present disclosure to this. In the drawings:

FIG. 1 schematically illustrates a schematic diagram of a known bearing monitoring device;

FIG. 2 schematically illustrates a schematic diagram of a rotating equipment monitoring device according to an embodiment of the present disclosure;

FIG. 3 schematically illustrates a part of a rotating equipment monitoring device according to an embodiment of the present disclosure;

FIG. 4 schematically illustrates an exploded schematic diagram of a part of the rotating equipment monitoring device shown in FIG. 3;

FIG. 5 schematically illustrates an assembly diagram of a part of the rotating equipment monitoring device shown in FIG. 3;

FIG. 6 schematically illustrates a part of the rotating equipment monitoring device according to another embodiment of the present disclosure;

FIG. 7 schematically illustrates an exploded schematic diagram of a part of the rotating equipment monitoring device shown in FIG. 6;

FIG. 8 schematically illustrates a part of the rotating equipment monitoring device according to another embodiment of the present disclosure;

FIG. 9 schematically illustrates an exploded schematic diagram of a part of the rotating equipment monitoring device shown in FIG. 8; and

FIG. 10 schematically illustrates an assembly diagram of a part of the rotating equipment monitoring device shown in FIG. 8.

### DETAILED DESCRIPTION

In order to make the objects of technical solutions, technical solutions, and advantages of the present disclosure clearer, the following will provide a clear and complete description of the technical solutions of embodiments of the present disclosure in conjunction with the accompanying drawings of the specific embodiments. The same reference signs in the accompanying drawings represent the same components. It should be noted that the described embodiments are a portion of the embodiments of the present disclosure, rather than all of them. Based on the described embodiments of the present disclosure, all other embodiments obtained by one of ordinary skill in the art without the need for creative labor fall within the scope of protection of the present disclosure.

Unless otherwise defined, the technical or scientific terms used herein shall have the usual meaning understood by one of ordinary skill in the art to which this disclosure belongs. The use of “first”, “second”, and similar terms in the specification and claims of this patent application does not indicate any order, quantity, or importance, but is only used to distinguish different components. Similarly, similar words such as “one”, “a” or “an” do not necessarily indicate quantitative limitations. Words such as “including”, “comprising”, or “having” means that the components or objects that appear before the words, include the components or objects listed after the words and their equivalents, without excluding other components or objects. Words such as “connecting” or “coupling” are not limited to the physical or mechanical connections or couplings shown in the drawings, but can include their equivalent connections or couplings, whether direct or indirect. The terms “up”, “down”, “left”, “right”, etc. are only used to represent relative positional relationships. When the absolute position of the described object changes, the relative positional relationship may also change accordingly.

The following describes in detail the various implementations of the rotating equipment monitoring device according to the embodiments of the present disclosure with reference to various accompanying drawings.

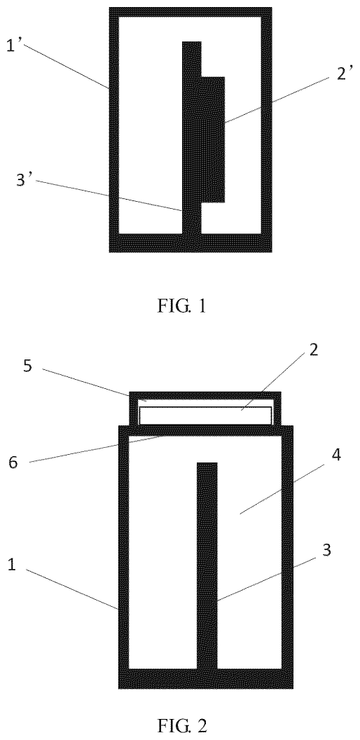

FIG. 1 shows a known bearing monitoring device, which comprises a housing 1′, an antenna 2′ located within the housing 1′, and a sensor assembly 3′. In addition, the housing 1′ is filled with an explosion-proof medium, such as AB adhesive, to completely encapsulate the antenna 2′ and the sensor assembly 3′. The sensor assembly 3′ comprises various sensors and a main circuit board on which the sensors are installed, and is therefore schematically shown as a board. The antenna 2′ can also be installed on the main circuit board. In the bearing monitoring device shown in FIG. 1, due to the impact of the explosion-proof medium on the antenna 2′, its transmission efficiency is relatively low. In addition, the antenna 2′ in the bearing monitoring device shown in FIG. 1 is arranged parallel to the main circuit board and is close to the main circuit board, which further affects the transmission efficiency. Therefore, the bearing monitoring device in FIG. 1 cannot be used for long-distance wireless transmission.

FIG. 2 shows a highly schematic diagram of an embodiment of a rotating equipment monitoring device according to the present disclosure, and the specific structure of the rotating equipment monitoring device may differ from that shown in FIG. 2. As shown in FIG. 2, the rotating equipment monitoring device comprises a housing 1, an antenna, a sensor assembly 3, and a cover. The rotating equipment monitoring device also includes a circuit board 2 on which the antenna is installed. The antenna is an NB-IOT antenna, which enables long-distance signal transmission with low-power consumption. The rotating equipment monitoring device of the present disclosure can particularly be a bearing monitoring device for measuring the speed, acceleration, temperature, vibration, etc. of bearings. Of course, the present disclosure is not limited to measuring bearings, but can also be used to measure parameters of other rotating equipment.

The housing 1 includes a first accommodating space 4 and a second accommodating space 5 which is located at an end of the housing 1 and separated from the first accommodating space 4, for example, by a partition wall 6 (or a top wall) near the end of the housing 1. Holes for filling the explosion-proof medium can be provided on the partition wall 6. For example, the housing 1 can be mostly made of plastic and can have a metal base. The housing 1 can have a roughly cylindrical shape, while the circuit board 2 with the antenna installed on it can have a shape that matches the circular cross-section of the housing 1, such as a roughly circular plate shaped component, and can have a thickness of approximately 1 mm. In other examples, the circuit board 2 with the antenna installed on it can have a polygonal shape, depending on the specific shape of the housing 1, especially the cross-sectional shape of the housing.

The sensor assembly 3 is arranged in the first accommodating space 4, which is filled with the explosion-proof medium that completely surrounds the sensor assembly 3. The explosion-proof medium can prevent explosions caused by the reaction of electric arcs and sparks that may be produced during the operation of the rotating equipment monitoring device with external gases. The explosion-proof medium can be an AB adhesive, such as a castable two-component casting resin based on polyurethane, which is composed of filling component A and isocyanate hardener B (MDI). The sensor assembly 3 can be arranged on or as part of the main circuit board, i.e. PCBA board, for example. The main circuit board includes but is not limited to temperature and gravity acceleration sensor chips, battery and sensor system power management devices, and various electronic components. The sensor assembly 3 can include a sensor chip for sensing the speed, acceleration, temperature, etc. of the bearing to be monitored. For example, the above sensors can be piezoelectric or MEMS sensors. The signal sensed by the sensor can be processed and calculated by a microcontroller MCU after passing through the signal processing circuit (such as amplifier, filter) on the PCBA board, and then transmitted to a remote control device in the cloud by the NB-IOT module through the antenna. The sensed data can be transmitted to the cloud through the NB-IOT antenna, and then fault diagnosis can be performed on the data stored in the cloud before notifying the user to maintain the device. For example, the data can include signals representing temperature or vibration data, as well as alarm signals representing temperature or vibration.

As shown in FIG. 2, the circuit board 2 or antenna is arranged substantially perpendicular to the sensor assembly 3, which further avoids the impact on the transmission rate caused by the antenna arranged parallel to the main circuit board.

In order to achieve signal transmission with sensor assembly 3, the antenna installed on circuit board 2 is configured to communicate with the sensor assembly 3, such as with RF wired connection, and is located in the second accommodating space 5. Specifically, the sensor assembly 3 or main circuit board located in the first accommodating space 4 can be electrically connected to the antenna located in the second accommodating space 5 through cables.

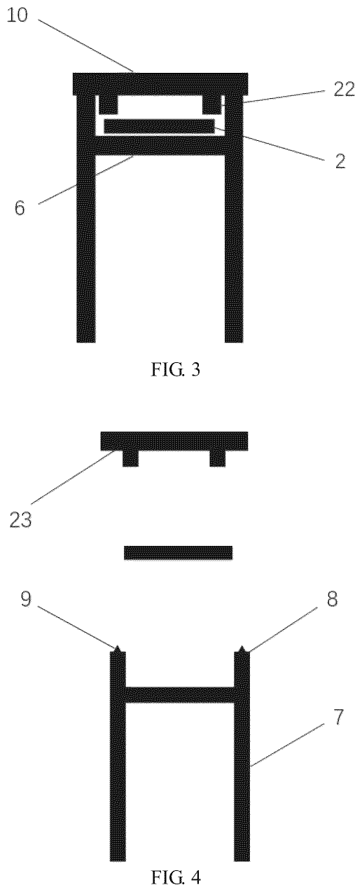

As shown in FIGS. 3 to 10, the rotating equipment monitoring device includes a cover 10, which is installed on the housing 1 by a cover installation portion (as described below) at an end of a sidewall 7 of the housing to seal the antenna or circuit board 2 in the second accommodating space 5. The cover 10 can be a transparent plastic cover, such as a plastic sheet or plate made of PC or PET material. By using the plastic cover to encapsulate the antenna, the additional impact of external structures (such as the cover) on antenna transmission efficiency can be reduced. Of course, the cover 10 can also be made of opaque material, which meets the IP69K, explosion-proof sealing requirements, and the appearance is consistent with the housing, for example, the two have the same color. Therefore, the cover also has a decorative effect, making the rotating equipment monitoring device of the present disclosure more aesthetically pleasing.

As shown in FIGS. 3 to 5, the cover installation portion is set as a protrusion 9 extending from an end face 8 of the sidewall of the housing 1 in a longitudinal direction, and the cover 10 can be connected to the protrusion 9. The “longitudinal direction” refers to the vertical upward direction in the figure, which is the direction in which the housing extends. The protrusion 9, for example, has a triangular cross-section and is integrated with the housing 1. The protrusion 9 is connected to an inner surface 23 of the cover 10 by melting or welding the protrusion 9. The inner surface 23 of the cover 10 refers to the surface of the cover 10 facing the second accommodating space 5. For example, the protrusion 9 can be made of a photosensitive material and can be melted by laser irradiation. Ultrasonic welding can also be used to weld the protrusion 9. The protrusion 9 is set as a continuous circumferential protrusion on the end face 8 of the sidewall of the housing 1 or a plurality of sub protrusions arranged intermittently on the end face 8 of the sidewall of the housing 1 in a circumferential direction. In the case of the continuous circumferential protrusion, the rotating equipment monitoring device does not require additional sealing devices to seal the second accommodating space.

In addition, the cover 10 can include a limiting portion 22, which extends from the inner surface 23 of the cover 10 towards the second accommodating space 5 and presses against the circuit board 2. In this way, it can be ensured that the position of the circuit board 2 remains unchanged.

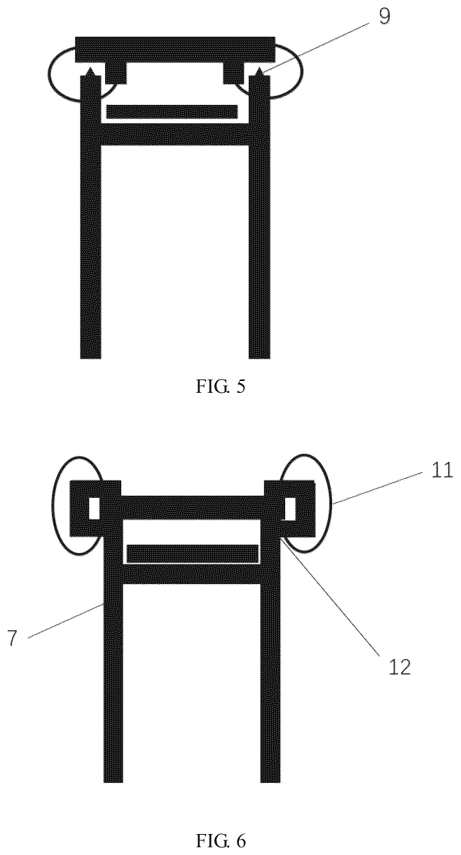

Referring again to FIGS. 4 to 5, the assembly of the rotating equipment monitoring device of the present disclosure can include the following steps: placing the circuit board 2 with an antenna on it in the second accommodating space 5; installing the cover 10 at the end of the housing 1; bonding the cover 10 to the end of the housing 1 by melting or welding the protrusion 9.

In addition to the cover installation portion of the above structure, other embodiments disclosed in the present disclosure can also implement the cover installation section by means of snap-fit, interference fit, etc.

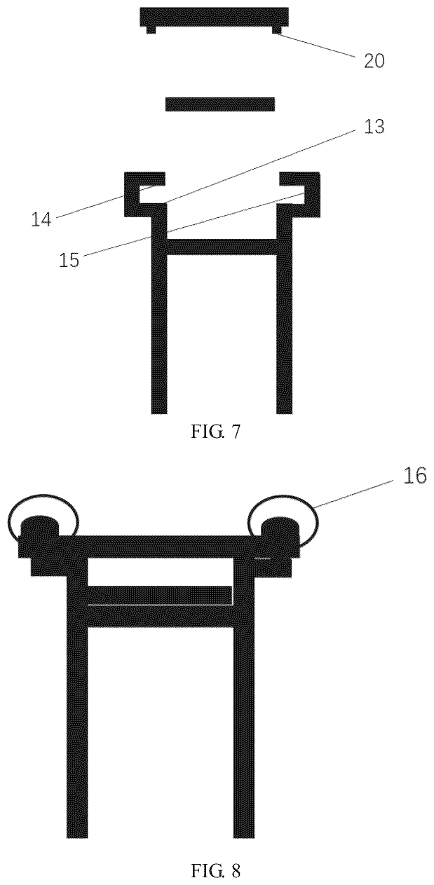

As shown in FIGS. 6 and 7, the cover installation portion is a groove installation portion 11 arranged above and connected to the end 12 of the sidewall of the housing 1, and the circumferential edge of the cover 10 is snapped in a groove of the groove installation portion 11. The notch of the groove faces the inner side of the sidewall 7 of the housing 1, and the sidewalls 13, 14, and bottom wall 15 of the groove installation portion 11 are located on the outside of the sidewall 7 of the housing 1. The sidewalls 13 and 14 of the groove installation portion 11 are designated relative to the groove open to the inner side of the sidewall of the housing. Through the above design, cover 10 can be snapped in the groove. In some examples, the end of the upper sidewall 14 of the groove installation portion 11 (i.e., the end near the inner side of the housing) may have a sloping structure to facilitate the cover 10 to enter the groove.

As shown in FIGS. 8 to 10, the cover installation portion includes a transverse portion 17 extending from the end 12 of the sidewall of the housing 1 in a transverse direction, and at least one extension portion 16 extending from the transverse end of the transverse portion in a longitudinal direction of the housing. The cover 10 includes openings 18 for the at least one extension portion 16 to pass through. The “transverse direction” refers to the horizontal direction in the figure, which is the direction perpendicular to the longitudinal extension direction of the housing. The cover installation portion is connected to the outer surface 21 of the cover 10 by melting or welding a part of the at least one extension portion 16 on the outside of the opening. The outer surface 21 of the cover 10 refers to the surface of the cover 10 facing away from the second accommodating space 5. For example, the part of the at least one extension 16 outside the opening may be melted by applying heat to it, or by laser welding or ultrasonic welding of the part outside the opening.

Referring again to FIGS. 8 to 10, the assembly of the rotating equipment monitoring device of the present disclosure can include the following steps: placing the circuit board 2 with an antenna on it in the second accommodating space 5; installing the cover 10 at the end of the housing 1, so that at least one extension portion 16 of the cover installation portion passes through the opening 18 on the cover 10 (as shown in FIG. 10); bonding the cover installation portion to the outer surface 21 of the cover 10 by melting or welding the part of the at least one extension portion 16 on the outside of the opening.

Specifically, as shown in FIG. 8, the extension 16 has a size larger than the opening 18 after melting or welding treatment, thereby achieving the fixed installation of the cover 10.

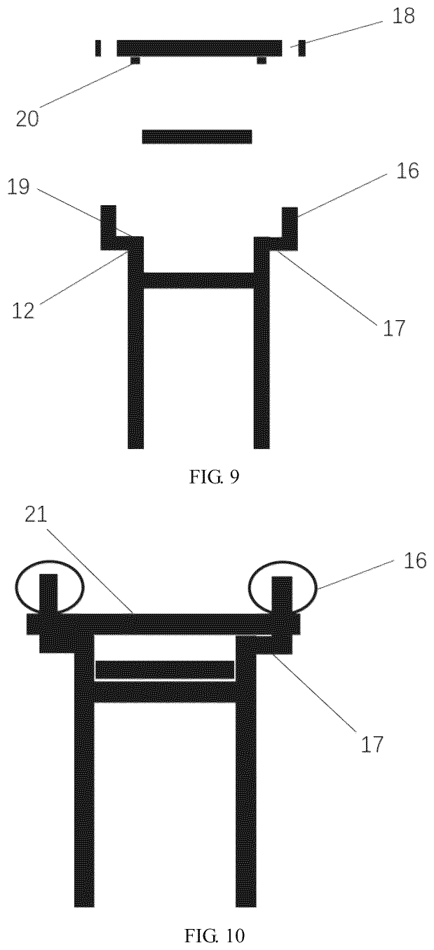

In order to achieve sealing effect, the rotating equipment monitoring device also includes a sealing device 20, as shown in FIGS. 7 and 9. The sealing device 20 is arranged between the inner surface 23 of the cover 10 and the end face of the sidewall of the housing 1. The end face of the sidewall of the housing 1 is provided with a sealing groove for accommodating the sealing device, and the position of the sealing groove is schematically shown with the reference sign 19 in FIG. 9. For example, the sealing device 20 can be made of rubber and is therefore compressible. Alternatively, the sealing device 20 can be a sealant.

In the rotating equipment monitoring device mentioned above, the antenna is not encapsulated by the explosion-proof medium and is located in a space separated from the sensor assembly and related circuits. Therefore, the rotating equipment monitoring device has high transmission efficiency and can meet the requirements of Nc sealing explosion-proof level. In addition, the explosion-proof medium is used to encapsulate the sensor assembly such that the rotating equipment monitoring device has high monitoring sensitivity and good temperature resistance performance. The use of the sealing device mentioned above enables the rotating equipment monitoring device to have good sealing performance and thus high reliability.

Specifically, the rotating equipment monitoring device of the present disclosure can achieve an average transmission efficiency as high as more than 30%, which can meet the requirements of sufficiently long transmission coverage and reduce communication power consumption, thereby extending the service life of the sensor. Based on the above transmission efficiency, the rotating equipment monitoring device of the present disclosure can use narrowband wireless communication technology, such as Narrow Band Internet of Things (NB-IOT), to achieve long-distance wireless transmission, thereby achieving the function of long-distance communication and uploading data to the cloud, without relying on a gateway. Specifically, through the wide-area wireless communication technology such as NB-IOT, diagnostic data can be uploaded to the cloud, including rotating equipment alarm data, spectrum raw data (for manual or intelligent diagnosis) and so on.

Furthermore, the rotating equipment monitoring device with a 2-zone explosion-proof rating of the present disclosure can be used in areas with gas explosion hazards and areas with dust explosion hazards, meeting the explosion-proof requirements of customers. The rotating equipment monitoring device of the present disclosure has passed Ex nC IIC T4 Gc certification in areas with gas explosion hazards in accordance with national standards GB 3836.1-2021 and GB 3836.8-2021, and passed Ex tc IIIC T135° C. Dc certification in areas with dust explosion hazards in accordance with national standards GB 3836.1-2021 and GB 3836.8-2021. The above certifications cannot be achieved by existing rotating equipment monitoring devices that are based on wide area network wireless communication such as NB-IOT and have passed 2-zone explosion-proof certification.

The disclosed technical features mentioned above are not limited to combinations with other features that have already been disclosed. Those skilled in the art may also combine other technical features according to the object of the disclosure, in order to achieve the object of the present disclosure.

What is claimed is:

1. A rotating equipment monitoring device comprising:
a housing comprising a first accommodating space and a second accommodating space, wherein the second accommodating space is located at an end of the housing and separated from the first accommodating space;
a sensor assembly arranged in the first accommodating space, wherein the first accommodating space is filled with an explosion-proof medium that completely surrounds the sensor assembly;
an antenna configured to communicate with the sensor assembly and arranged in the second accommodating space; and
a cover installed on the housing via a cover installation portion at an end of a sidewall of the housing to seal the antenna in the second accommodating space.

2. The rotating equipment monitoring device according to claim 1, wherein the cover installation portion is a protrusion extending from an end face of the sidewall of the housing in a longitudinal direction, and the cover can be connected to the protrusion.

3. The rotating equipment monitoring device according to claim 2, wherein the protrusion is connected to an inner surface of the cover by melting or welding the protrusion.

4. The rotating equipment monitoring device according to claim 2, wherein the protrusion is set as a continuous circumferential protrusion on the end face of the sidewall of the housing or a plurality of sub protrusions intermittently arranged on the end face of the sidewall of the housing in a circumferential direction.

5. The rotating equipment monitoring device according to claim 1, wherein the cover installation portion is a groove installation portion arranged above and connected to the end of the sidewall of the housing, and a circumferential edge of the cover is snapped in a groove of the groove installation portion.

6. The rotating equipment monitoring device according to claim 5, wherein a notch of the groove faces an inner side of the sidewall of the housing, and the sidewalls and bottom wall of the groove installation portion are located on the outside of the sidewall of the housing.

7. The rotating equipment monitoring device according to claim 1, wherein the cover installation portion comprises a transverse portion extending from the end of the sidewall of the housing in a transverse direction and at least one extension portion extending from a transverse end of the transverse portion in a longitudinal direction of the housing, and the cover comprises openings for the at least one extension portion to pass through.

8. The rotating equipment monitoring device according to claim 7, wherein the cover installation portion is connected to an outer surface of the cover by melting or welding a part of the at least one extension portion on the outside of the opening.

9. The rotating equipment monitoring device according to claim 5, wherein the rotating equipment monitoring device further comprises a sealing device, which is arranged between an inner surface of the cover and the end face of the sidewall of the housing, and a sealing groove is arranged on the end face of the sidewall of the housing to accommodate the sealing device.

10. The rotating equipment monitoring device according to claim 1, wherein the rotating equipment monitoring device further comprises a circuit board for installing the antenna, and the cover comprises a limiting portion which extends from an inner surface of the cover towards the second accommodating space and presses against the circuit board.

11. The rotating equipment monitoring device according to claim 7, wherein the rotating equipment monitoring device further comprises a sealing device, which is arranged between an inner surface of the cover and the end face of the sidewall of the housing, and a sealing groove is arranged on the end face of the sidewall of the housing to accommodate the sealing device.
